(19) United States
(12) Patent Application Publication
(10) Pub. No.: US 2006/0266780 A1
(43) Pub. Date: Nov. 30, 2006

(54) Universal running board mounting bracket

(75) Inventors: Bradford D. Armstrong, Barrie (CA); Rudolph A. Schrempf, Brampton (CA)

Correspondence Address: WARN, HOFFMANN, MILLER & LALONE, .P.C, PO BOX 70098, ROCHESTER HILLS, MI, 48307, US

(73) Assignee: Magna International Inc., Aurora (CA)

(21) Appl. No.: 11/441,307

(22) Filed: May 25, 2006

Related U.S. Application Data
(60) Provisional application No. 60/684,271, filed on May 25, 2005.

(51) Int. Cl. B60R 11/00

(52) U.S. Cl. 224/545

(57) ABSTRACT

A series of brackets is provided that have a universal base, but have unique mounting features which are used to mount a running board onto a vehicle's inner rocker panel. The running boards have a support which has a universal mounting surface that can accept the bracket's universal base in order for the bracket to attach to the support. The top of the bracket can be shaped differently in order to avoid obstructions on the vehicle's inner rocker panel. Therefore, the running board can be mounted easier because the top of the bracket can be shaped to avoid the inner rocker panel's obstructions and the bottom can be formed to the universal shape in order to fit the running board's support.

### CROSS-REFERENCE TO RELATED APPLICATIONS

This application claims the benefit of U.S. Provisional Application No. 60/684,271, filed May 25, 2005.

### FIELD OF THE INVENTION

The present invention relates to a universal running board mounting bracket arrangement

### BACKGROUND OF THE INVENTION

It is known that running boards can be attached to a vehicle's inner rocker panel. A vehicle's inner rocker panel differs between vehicle models because the inner rocker panels can be shaped differently depending on the vehicle model. For example, a rocker panel can have uneven surfaces or curvatures in different areas depending on the vehicle model. In addition, there can be other components attached or placed against the vehicle's inner rocker panel causing an obstruction for mounting a running board; such as bolts, cross-beams for the vehicle's frame, wiring, cables, flanges, etc.

Due to the different vehicle models having unique inner rocker panels it can be both time consuming and costly to attach a running board. The reason for the difficulty is that each running board and the attachment bracket must be configured to a particular vehicle model in order to attach the running board around any obstructions of the vehicle's inner rocker panel.

Accordingly, it is desirable to have a bracket system which enables running boards to be easily mounted onto different vehicle models. The present invention provides a support that attaches to a running board, which has a universal mounting surface. The present invention also includes a series of brackets that have a universal base, but have unique mounting features, which can be used in a variety of combinations in order to avoid the inner rocker panel's obstructions. Since all of the unique brackets have a universal base the brackets can be attached to the running board's support.

### SUMMARY OF THE INVENTION

The present invention relates to a series of brackets that have a universal base, but have unique mounting features which are used to mount a running board onto a vehicle's inner rocker panel. Together the series of brackets provide a universal attachment system capable of being used on a wide range of vehicle models. The running boards have a support which has a universal mounting surface that can accept the bracket's universal base in order for the bracket to attach to the support. The brackets have a universal base with a shape that enables the bracket to attach to the support. The top of the bracket can be shaped differently in order to avoid obstructions on the vehicle's inner rocker panel. Therefore, the running board can be mounted easier because the top of the bracket can be shaped to avoid the inner rocker panel's obstructions and the bottom can be formed to the universal shape in order to fit the running board's support.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1a is a perspective side view of an alternate embodiment of the plastic mount attached to the running board;

FIG. 1b is a perspective side view of an alternate embodiment where multiple brackets are attached to the plastic mount;

FIG. 2a is a perspective side view of a preferred embodiment where the metal mounting surface is attached to the running board;

FIG. 2b is a perspective side view of a fourth embodiment showing the mounting surface and the bracket base having alternate embodiments;

FIG. 3 is a perspective side view of a fifth embodiment showing the mounting surface having an alternate embodiment;

FIG. 4 is a perspective side view of a sixth embodiment where the bracket extensions have alternate embodiments;

FIG. 5 is a perspective side view of a seventh embodiment where the bracket base is offset; and

FIG. 6 is a perspective side view of an eighth embodiment showing an alternate embodiment of the bracket, where the bracket can be mounted to the floor board of a vehicle

### DETAILED DESCRIPTION OF THE PREFERRED EMBODIMENTS

The following description of the preferred embodiment(s) is merely exemplary in nature and is in no way intended to limit the invention, its application, or uses.

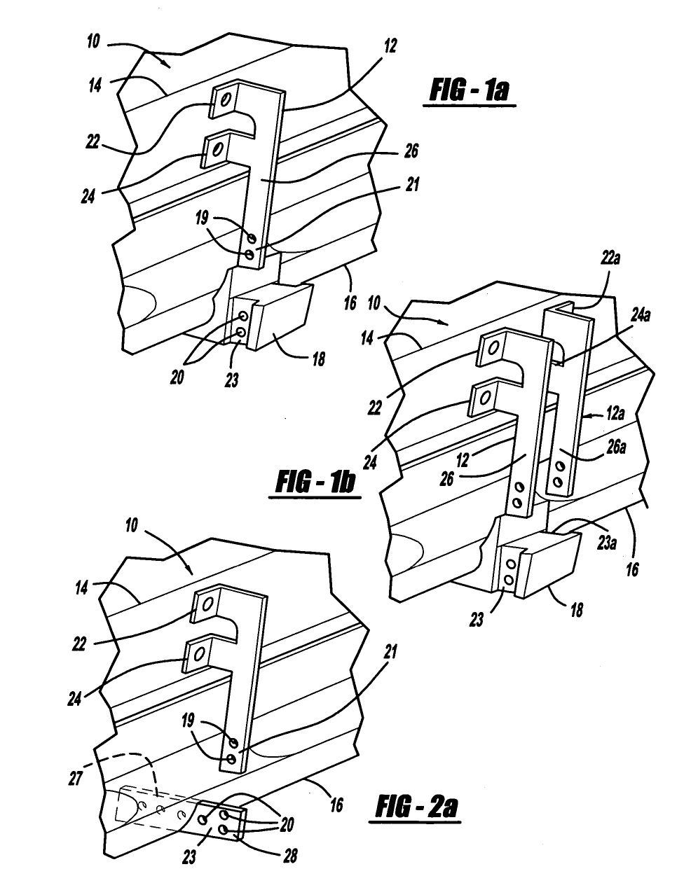

FIG. 1 shows an embodiment of a bracket assembly 10 having a bracket 12 attached to an inner rocker panel 14. A running board 16 is stamped and has a support 18. The support 18 attaches to the running board 16 and the bracket 12 is then fastened to the support 18. The support 18 can be separately attached or integrally formed with the running board 16. The use of the support 18 is not essential to the invention, but rather provides a universal attachment to the running board 16 that can be molded from polymeric material. The bracket 12 is fastened to the support 18 by aligning and extending bolts through holes 19 on the bracket 12 with holes 20 on the support 18. The holes 19 on the bracket 12 are located on bracket's base 21, which has a standardized shape and size. The holes on the support 20 are located on the support's mounting surface 23, which has a standardized shape and size in order to correspond with the base 21. The bracket 12 has an upper extension 22 and a lower extension 24, which both extend perpendicular to a face 26 of the bracket 12. The upper extension 22 has and lower extension 24 are used to fasten the bracket 12 to the inner surface of the vehicle's rocker panel 14.

FIG. 1b shows another alternate embodiment of the bracket assembly 10 having a left bracket 12 and a right bracket 12a. The left bracket 12 has the same design and features as the first embodiment's bracket 12. The right bracket 12a is a mirror image of the left bracket 12, where both an upper extension 22a and a lower extension 24a extend perpendicular to the bracket's face. The support 18 has the same design and features as described in the first embodiment. The left bracket 12 attaches to the left side mounting surface 23. The right bracket 12a attaches to the right side mounting surface 23a. Since the right bracket 12a is a mirror image of the left bracket 12, when the brackets 12 and 12a are attached to the mounting surfaces 23 and 23a respectively, upper extension 22 and lower extension 24 should extend away from the right bracket 12a and upper extension 22a and lower extension 24a should extend away from the left bracket 12. Having multiple brackets 12 connected to a similar support 18 can be advantageous because more support is given to the mounted running board 16. Furthermore, having upper extensions 22 and 22a and lower extensions 24 and 24a extending in different directions respectively allows for the brackets 12 and 12a to be mounted to same support 18 and avoid any obstructions on the inner rocker panel 14.

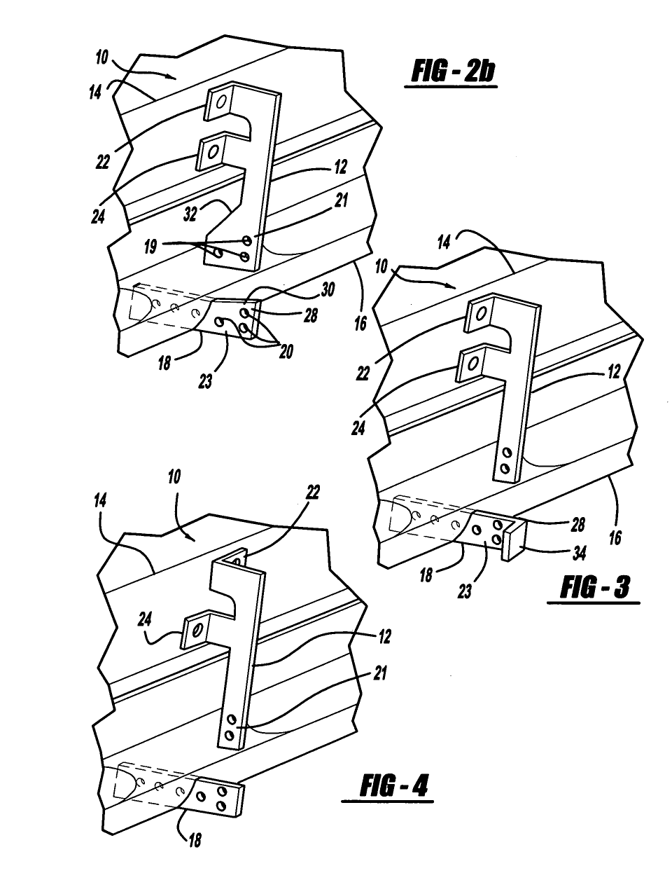

FIG. 2a shows a third embodiment of the bracket assembly 10. The running board 16 has a horizontal slot 27, such that the support 18 can be placed into the horizontal slot 27. In the preferred embodiment the support 18 is metal having rectangular shape, and can be bolted to the running board 16 inside the horizontal slot 27. The support 18 has an exposed area 28 that has a rectangular shaped and longitudinally extends out of the horizontal slot 27 on an inner side of the running board 16. The exposed area 28 creates the mounting surface 23. The bracket's base 21 is connected to the mounting surface 23 as described in the first embodiment. The mounting surface 23 consists of three holes 20 in order to accept the bracket's base 21. The bracket 12 has the same design and features as described in the first embodiment.

FIG. 2b shows a fourth embodiment of the bracket assembly 10. The running board 14 has some of the same design and features as described in FIG. 2a. As the exposed area 28 extends out of the running board's 16 inner side, the contact area's top side 30 is angled such that the height of the end of the exposed area 28 is greater than the height of the portion of the exposed area 28 that is closer to the running board 16. The bracket 12 has an upper extension 22 and a lower extension 24 as described in the first embodiment. The bracket's base 21 has an angled side 32 that extends from the inner rocker panel 14 towards the running board 16. The angled side 32 causes the length of the bracket's base 21 to increase as the bracket's base 21 extends from the inner rocker panel 14 to the running board 16. Even though the exposed area 28 has a different shape and the bracket's base 21 is offset, the mounting surface 23 remains the same as described in the other embodiments in order for the bracket's base 21 to attach to the support 18. The offset created by the angled side 32 is beneficial because the bracket can have a more secure attachment to the support 18. In this embodiment, the bracket 12 has three holes 19 which are aligned with the mounting surface's three holes 20 which provide secure attachment. In addition, the offset allows the bracket's base 21 to have a larger length without requiring the entire bracket 12 to be larger which may not be possible due to obstructions on the inner rocker panel 14.

A fifth embodiment of the bracket assembly 10 is shown in FIG. 3. The bracket 12 has the same design and features as described in the first embodiment. The exposed area 28 has an L-shaped end 34 that is perpendicular to the mounting surface 23. The mounting surface 23 maintains the same shape as described in the other embodiments, which allows the bracket's base 21 to attach to the support 18 even though the exposed area 28 has an L-shaped end 34. The shape of the exposed area 28 is advantageous because the twisting of the bracket assembly 10 is minimized, this allows the bracket assembly 10 to support more weight.

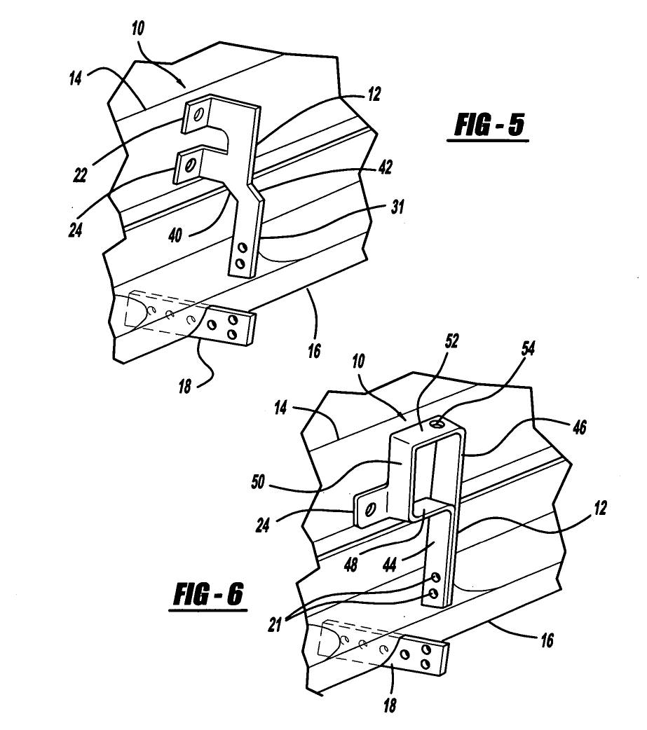

A sixth embodiment of the bracket assembly 10 is shown in FIG. 4. The support 18 has the same design and features as described in the third embodiment. The bracket 12 has an upper extension 22 and a lower extension 24, where the upper extension 22 and lower extension 24 extend in opposite directions. The base 21 maintains the same design as described in the other embodiments in order for the bracket's base to be able to attach to the support 18. It is advantageous to have a bracket 12 where the upper extension 22 and the lower extension 24 extend in opposite directions because the bracket 12 can avoid an inner rocker panel's 14 obstructions or be used if the inner rocker panel 14 has an uneven mounting surface.

FIG. 5 shows a seventh embodiment of the bracket assembly 10. The support 18 has the same design and features as described in the third embodiment. The bracket 12 has an upper extension 22 and a lower extension that extend in the same direction, perpendicular to the face 26 of the bracket 12. The bracket 12 has an inner angled surface 40 and an outer angled surface 42, which are parallel to one another. The inner angled surface 40 and the outer angled surface 42 extend at an angle that is towards the running board 16 but away from the inner rocker panel 14. The inner angled surface 40 and the outer angled surface 42 cause the base 21 to be offset from the portion of the bracket 12 that attaches to the inner rocker panel 14. Even though the bracket's base 21 is offset due to the inner angled surface 40 and the outer angled surface 42 the shape of the bracket's base 21 remains the same so that it can be attached to the support 18. The offset created by the inner angled surface 40 and the outer angled surface 42 is beneficial because the bracket 12 can avoid any obstructions on the inner rocker panel 14. In addition, the offset allows the bracket 12 to be used if the inner rocker panel 14 has an uneven mounting surface.

An eighth embodiment of the bracket assembly 10 is shown in FIG. 6. The support 18 has the same design and features as described in the third embodiment. The bracket 12 has a short segment 44 and a long segment 46. At the base 38 of the bracket 12 the short segment 44 and the long segment 46 are parallel, which forms the bracket's base 21. Even though the bracket's base 21 may have a greater width than the bracket's base 21 described in other embodiments due to the bracket's base 21 being formed by the short segment 44 and the long segment 46, the bracket's base 21 has the same shape as described in the other embodiments the bracket's base can still be attached to the support 18. The short segment 44 has a shorter height than the long segment 46, so that connected to the top of the short segment 44 is a bottom segment 48 that extends perpendicular to the short segment 44. The end of the bottom segment 48 that is not connected to the shorter segment 44, connects to a side segment 50. The side segment 50 extends parallel to the long segment 46 from the bottom segment 48 away from the running board 14. Attached to the side segment 50 is a lower extension 24 that extends parallel to the bottom segment 48 away from the longer segment 46. The lower extension 24 is used to attach the bracket 12 to the inner rocker panel 14. The side segment 50 and the long segment 46 are connected by a top segment 52 which is parallel to the bottom segment 48. The top segment 52 can be used to attach the bracket 12 to the floor of the vehicle (not shown), preferably by extending a bolt through the top segment's hole 54 and into the floor of the vehicle. It is beneficial to have a bracket 12 that has the ability to be mounted to the floor of the vehicle in order to give more support to the running board, and to avoid any obstructions or uneven surfaces on the inner rocker panel 14.

A preferred embodiment of the present invention is shown in FIG. 2a. FIGS. 2b-6 show alternate embodiments of the bracket 12 and alterations of a preferred embodiment of the support 18, which can be used depending on the obstructions on the inner rocker panel 14. FIGS. 1a and 1b show alternate embodiments of the support 18. It is preferred that in any of the embodiments at least two bracket assemblies 10 be used to mount the running board 16 to the inner rocker panel 14. Additional bracket assemblies 10 can be used depending on the length of the running board 16.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A universal running board mounting bracket system comprising:
a bracket having a base with a universal shape;
a support wherein said support has at least one hole; and
said support has a mounting surface and said mounting surface corresponds with said universal shape in order for said bracket to attach to said support.

2. The universal running board mounting bracket system of claim 1 wherein said base has at least one hole.

3. The universal running board mounting bracket system of claim 1 wherein said mounting surface has at least one hole.

4. The universal running board mounting bracket system of claim 1 wherein said support is attached to a running board.

5. The universal running board mounting bracket system of claim 4 wherein said running board has a horizontal slot where said support attaches to said running board.

6. The universal running board mounting bracket system of claim 5 wherein said support extends longitudinally through said horizontal slot.

7. The universal running board mounting bracket system of claim 6 wherein said support has an exposed area that extends out of said horizontal slot, and said exposed area forms said universal mounting surface.

8. The universal running board mounting bracket system of claim 1 wherein said bracket is connectable to a rocker panel.

9. The universal running board mounting bracket system of claim 1 wherein said bracket has at least one extension that is generally perpendicular to said bracket.

10. The universal running board mounting bracket system of claim 9 wherein said extensions have at least one hole.

11. A universal running board mounting bracket system comprising:
a bracket for connecting to a vehicle body wherein said bracket has a base with a universal shape; and
a support having a mounting surface connectable with said base, said support being connectable to one or more running boards.

12. The universal running board mounting bracket system of claim 11 wherein the shape of said bracket is angled to allow said bracket to be mounted around an obstruction.

13. The universal running board mounting bracket system of claim 11 wherein said running board has a horizontal slot for said support to attach to said running board.

14. The universal running board mounting bracket system of claim 11 wherein said support is integrally formed with said running board.

15. The universal running board mounting bracket system of claim 11 further comprising one or more extensions extending generally perpendicular from said bracket for mounting said bracket to said vehicle body.

16. The universal running board mounting bracket system of claim 11 wherein said bracket has a side segment with an extension for connecting said bracket to a vehicle and a top segment for attaching said bracket to another portion of said vehicle.

17. The universal running board mounting bracket system of claim 11 further comprising a second bracket having a base connectable to a second mounting surface on said support.

18. A universal running board mounting bracket system comprising:
a vehicle body;
one or more running boards;
one or more brackets each having a base for connecting to various locations on said vehicle body; and
one or more supports connected to each said running board, wherein each said support is connectable to one or more base portions of said mounting bracket.

19. The universal running board mounting bracket system of claim 18 wherein said one or more supports are each integrally formed with said running board.

20. The universal running board mounting bracket system of claim 18 further comprising one or more extensions extending generally perpendicular from each one of said one or more brackets for mounting said bracket to said vehicle body.
